(19) United States
(12) Patent Application Publication
(10) Pub. No.: US 2011/0150304 A1
(43) Pub. Date: Jun. 23, 2011

(54) PERSONAL AUTHENTICATION APPARATUS AND MOBILE COMMUNICATION TERMINAL

(76) Inventors: Tadayuki Abe, Ichinoseki (JP); Kyoichi Takahashi, Fujisawa (JP); Hiromi Sugo, Kanegasaki (JP); Shinichiro Aikawa, Fujisawa (JP)

(21) Appl. No.: 12/854,238

(22) Filed: Aug. 11, 2010

(30) Foreign Application Priority Data
Dec. 21, 2009 (JP) 2009-288600

(51) Int. Cl. G06K 9/00

(52) U.S. Cl. 382/124

(57) ABSTRACT

A personal authentication apparatus, being small/thin and also enabling to position a vital body with high accuracy, comprises: a first light source and a second light source, each of which is configured to irradiate infrared rays; and detector portion, which is configured to detect the infrared rays irradiated from the first and second light sources upon a vital body, whereby detecting a picture having characteristic information of the vital body from the infrared rays detected by the detector portion and executing a personal authentication, wherein irradiation is made from the first and second light sources upon the vital body, and position information of the vital body is detected from the infrared rays detected by the detector portion, thereby executing non-contacting positioning of the vital body.

This application relates to and claims priority from Japanese Patent Application No. 2009-288600 filed on Dec. 21, 2009, the entire disclosure of which is incorporated herein by reference.

### BACKGROUND OF THE INVENTION

The present invention relates to a personal authentication apparatus. In particular, it relates to a personal authentication apparatus for authenticating a living body with using a finger vein or the like, for example.

In recent years, as a technology for executing a personal authentication through an authentication of a vital or living body is already known a finger vein authentication technology, for authenticating the finger vein as information of the vital body. Because of using a finger vein pattern, i.e., the characteristic information within an inside of the vital body, the finger vein authentication technology has a merit that it can achieve superior accuracy of authentication, and that a counterfeit or falsification thereof is difficult comparing to an authentication of the vital body, with using a fingerprint or the like, i.e., characteristic information on a surface of the vital or living body.

In the following Patent Document 1 is described, for the purpose of “providing a vital information reading apparatus for achieving small-sizing, while satisfying a photographing condition for obtaining a clear picture quality with maintaining a necessary photographing distance from an image pickup portion up to a vital body”, “the living body information reading apparatus having a light source for emitting a light, an image pickup portion for picking up an image or picture of a vital body, upon which the light from said light source is irradiated, a vital body holding portion for holding said vital body at a photographing position, and a main body of the apparatus mounting those thereon, thereby having such construction that said vital body holding portion is fold back into an inside of the main body of the apparatus, to be stored therein, when not reading the vital body, thereby achieving the small-sizing, and when reading the vital body, it is projected from a position of storing there to a position for holding the vital body.

### PRIOR ART DOCUMENTS

### Patent Documents

[Patent Document 1] Japanese Patent Laying-Open No. 2009-26039 (2009).

### BRIEF SUMMARY OF THE INVENTION

The finger vein authentication is spread, widely, in particular, in a field of business use, such as, an automated teller machine (ATM), achieving a high-degree of security and being requested high security level, or a log in of a personal computer, etc., for example; however, since it is difficult to be small and thin in the sizes thereof, comparing to the finger print authentication or the like, therefore a propagation thereof into general purpose consumer appliances does not proceed.

With the conventional finger vein authentication apparatus, infrared rays are irradiated on a finger under the condition that the finger touches on the apparatus, and a photographed pattern picture of the veins is obtained by an image pickup element; however, in this case, since almost of the parts of optical path length from the vein to the image pickup element lies inside the apparatus, there is a drawback that it is difficult to make up the apparatus being small and/or thin in the sizes thereof.

Also, though in the Patent Document 1 mentioned above is described that, when not reading the vital body, the vital body holding portion is folded to be stored inside the main body of the apparatus, thereby achieving the small-sizing, however with the conventional method of brining the finger to be in touch on the apparatus, there is a problem that the authentication performances are deteriorated, because of a position of the finger shifting due to influences of changes of shape or length of a nail of a user, or gradation of the vein pattern, which changes due to alteration of suppression pressure of the finger.

And, if trying to buildup the apparatus being small and/or thin in the sizes thereof, and also non-contact type with the finger, for the purpose of dissolving the problem of the conventional method of contacting the finger on the apparatus, it is a problem to be solved to fix the finger with high accuracy when photographing a picture of the vain pattern.

Further, when trying to make the apparatus non-contact type with the finger, it is also a problem to be solved, such as, to make an influence of noise components ineffective or un-influential, such as, external lights, reflection lights from a finger surface, etc., for example.

According to the present invention, for dissolving such drawbacks as was mentioned above, there are provided the structures, which are mentioned in the claims, for an example. In more details, for example, there is provided a personal authentication apparatus, comprising: a first light source and a second light source, each of which is configured to irradiate infrared rays; and detector portion, which is configured to detect the infrared rays irradiated from said first and second light sources upon a vital body, whereby detecting a picture having characteristic information of the vital body from the infrared rays detected by said detector portion and executing a personal authentication, wherein irradiation is made from said first and second light sources upon the vital body, and position information of the vital body is detected from the infrared rays detected by said detector portion, thereby executing non-contacting positioning of the vital body.

According to the present invention, it is possible to provide a personal authentication apparatus of vital body authentication type, being small and thin in the sizes thereof and also enabling to position a vital body with high accuracy.

Also, with enabling the small and thin sizing of the apparatus, it is possible to be installed into a mobile appliance, which can be used by a user carrying around it together, portably, and thereby advancing a propagation of the personal authentication apparatus of a vital or living body type into general consumer appliances.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a principle cross-section view for showing a vital authentication apparatus according to an embodiment of the present invention, under the condition of authentication of a finger as a target thereof;

FIG. 2 is a principle cross-section view for showing the vital authentication apparatus according to the embodiment of the present invention, under the condition of authentication of the finger as the target thereof;

FIGS. 3A and 3B are views for showing an outline of a finger position observation method with using reflection lights of infrared rays (when it is normal);

FIGS. 4A and 4B are views for showing an outline of the finger position observation method with using reflection lights of an infrared ray (when the finger is inclined);

FIGS. 5A and 5B are views for showing an outline of the finger position observation method with using reflection lights of the infrared ray (when the distance up to the finger does not fit);

FIGS. 6A and 6B are views for showing an outline of the finger position observation method with using reflection lights of the infrared rays (when the finger is twisted);

FIGS. 7A to 7C are views for showing an outline of the finger position observation method with using reflection lights of a visible ray (in case of two (2) points of light sources);

FIGS. 8A to 8C are views for showing an outline of the finger position observation method with using reflection lights of a visible ray (in case of four (4) points of light sources);

FIG. 9 is a view for showing an outline of the finger position observation method with using a liquid crystal monitor picture;

FIG. 10 is a view for showing absorbance characteristics of hemoglobin and wavelengths of the infrared ray to be used;

FIG. 11 is a function block diagram of an image processing apparatus;

FIG. 12 is a block diagram of the image processing apparatus; and

FIG. 13 is a flowchart for explaining about functions of the first embodiment of the present invention.

### DETAILED DESCRIPTION OF THE PREFERRED EMBODIMENTS

This vital authentication apparatus detects characteristic information of a finger, from a part of a vital or living body, such as, the finger; thereby executing an authentication of the vital body. Thus, the vital authentication apparatus irradiates an infrared ray for a light source, such as, a LED (Light Emitting Diode), etc., which is provided on a front surface of an apparatus (below the finger), when holding up the finger to the apparatus, but without contacting thereon, and then the infrared lights diffusing inside the finger are absorbed into veins, and also are scattered by or pass through organs other than the veins; thereby a picture is photographed upon basis of the infrared lights discharged to an outside of the finger with receiving influences of an internal environment of the finger, including the configuration of the veins of the finger (i.e., a vein pattern) therein, and from this picture, a personal authentication is executed by extracting the vein pattern as the characteristic information.

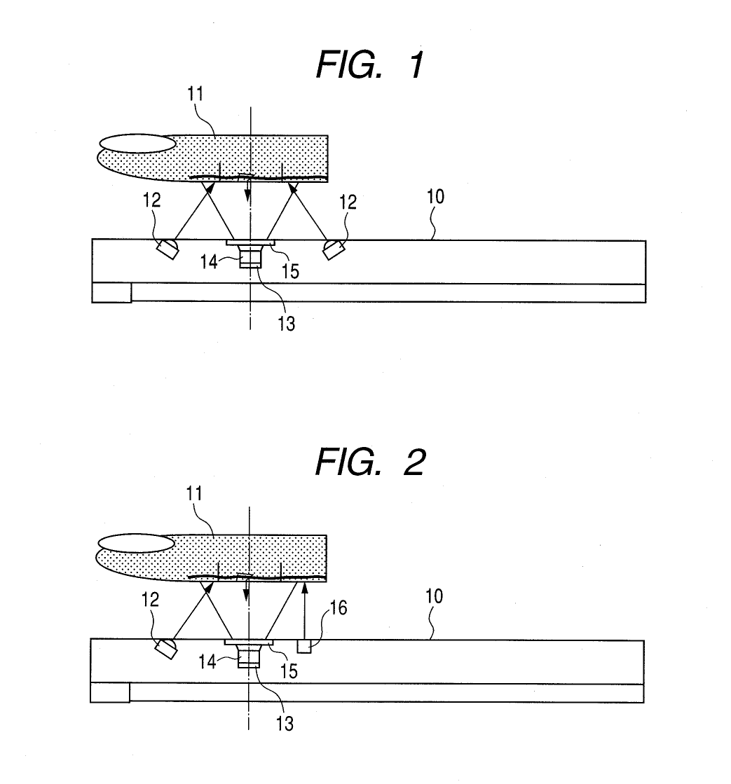

FIG. 1 is a principle cross-section view of a vital authentication apparatus (i.e., a first embodiment) in case where a target of authentication is a finger, as a part of a vital or living body.

In FIG. 1, the vital authentication apparatus comprises a housing 10, with an assumption of a mobile wireless terminal or mobile equipment, etc., such as, a portable telephone, for example. In an inside of the housing 10 are provided a detector portion for detecting a pattern picture of the finger vein as the characteristic information of the vital or living body, and a light source 12 for irradiating the infrared rays upon a finger 11 at a predetermined angle. In the present embodiment, that light source 12 has two (2) pieces thereof, which are disposed in almost symmetric around a center of that detector portion (for example, facing to each other by 180 degrees, etc.). For example, with the disposition of the light sources 12 in such a manner, it is possible to increases an accuracy of positioning, further, when positioning the vital body. The detector portion is built up with an image pickup element 13, a lens 14 for forming an image on the image pickup element 13, an IR filter 15 for passing the infrared rays through but cutting unnecessary visible lights off.

In the vital authentication apparatus shown in FIG. 2 (a second embodiment), comparing to the vital authentication apparatus shown in FIG. 1 (the first embodiment), the light source 12 is one (1) piece on one side, and on the other side is a position sensor 16, i.e., aiming stability of fixing the finger 11, which will be mentioned later, but being equal to the first embodiment, functionally.

Next, explanation will be given on a method for positioning the finger 11, which comes to a problem by brining the finger 11 to be in non-contact with the apparatus, by referring to the first embodiment.

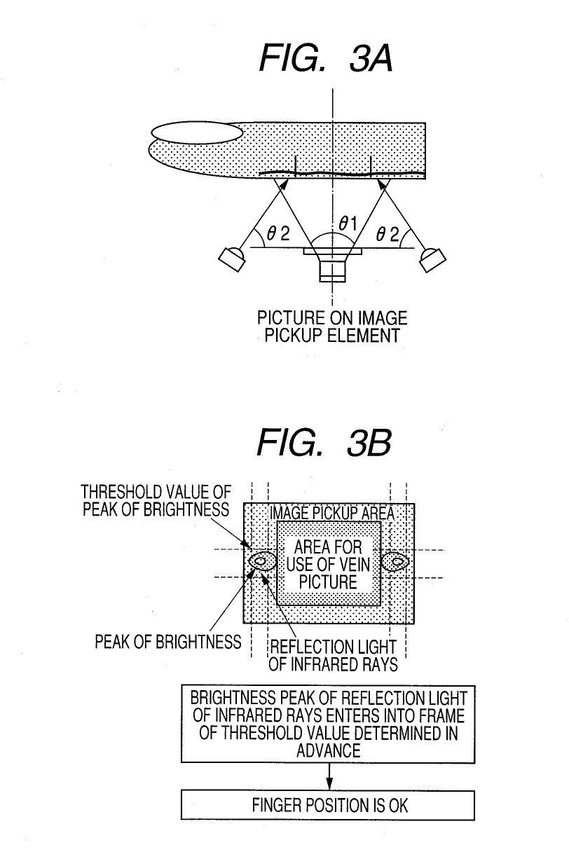

FIG. 3A shows the cross-section view of a principle portion when the finger 11 is disposed in parallel with the apparatus and at a correct distance, and FIG. 3B shows a picture, which can be obtained on the image pickup element 13 at that time.

In FIGS. 3A and 3B, assuming that an elevation angle “θ1” and a magnification of the lens 14 and also an irradiation angle “θ2” of the light source (s) 12 are constant, observation is made on a peak of brightness of the reflection light of the infrared rays of the light source(s) 12, with respect to the finger 11, on the image pickup element 13. In this case, a position of the peak of brightness, which the image pickup element 13 will detects, and a threshold value of magnitude of the brightness are set up in advance. Herein, the peak of brightness (or, the brightness peak) is an idea of showing a vicinity of a point where the brightness of the infrared rays goes up to the maximum, and in more details, it means an area or region, etc., for example, where the brightness lies from the vicinity of a maximum point thereof within a predetermined region of brightness. Detecting on whether the peak of brightness leis within this threshold value or not enables determination of whether the finger 11 is disposed to be in parallel with and at the correct distance, with respect to the apparatus. Namely, with making the irradiation angles “θ2” of two (2) sets (or, maybe plural numbers) of the light sources 12 constant, the infrared rays are irradiated upon the vital or living body, and detection is made on a position of the brightness peak of the reflection lights of infrared rays; thereby it is possible to detect height and position, etc., of specific two (2) (or, may be plural numbers of) points on the vital body, for example.

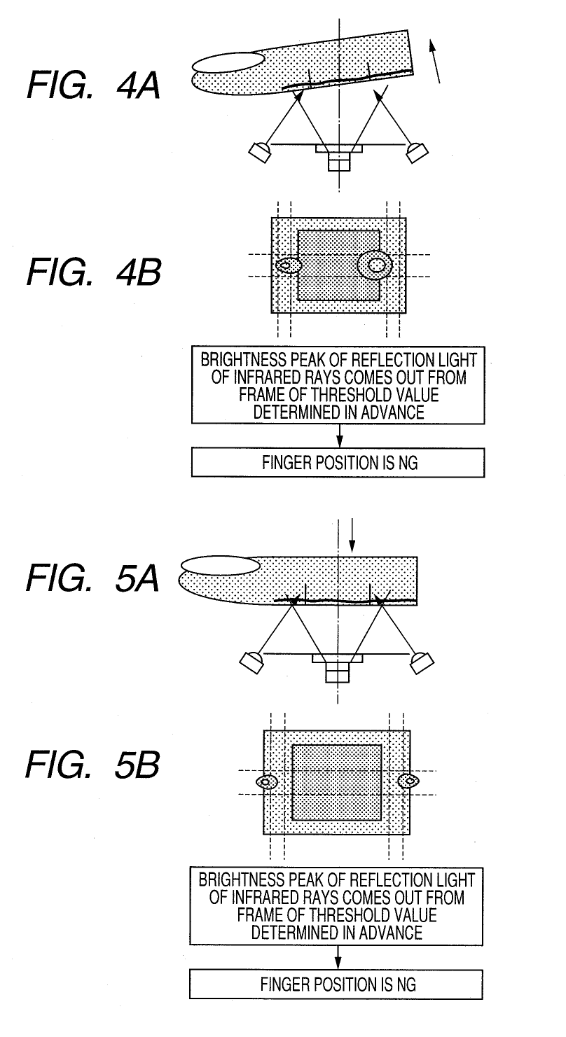

FIGS. 4A and 4B show an example, in which the finger 11 is inclined with respect to the apparatus, and FIGS. 5A and 5B show an example, in which the finger 11 does not fit in the distance with respect to the apparatus. In any case, the brightness peak comes out from the threshold value of the brightness peak; i.e., it is possible to determine that the finger 11 is not disposed to be in parallel with or at the correct distance, with respect to the apparatus.

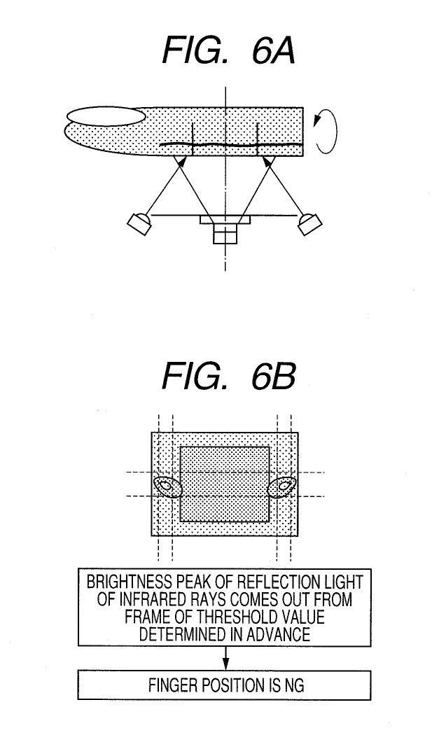

FIGS. 6A and 6B show an example of disposing the finger 11 twisted (or rotated) with respect to the apparatus. Although a center portion of a reverse side (i.e., a palm side) of the finger 11 is normally flat, but when the finger is twisted (or, rotated), as shown in FIGS. 6A and 6B, a configuration (i.e., a distribution of brightness) of the reflection lights of infrared rays differs from that when the finger 11 is disposed, correctly (i.e., under an ideal condition), as shown in FIGS. 3A and 3B. In this case, determining the threshold value to the configuration (i.e., the distribution of brightness) of the reflection lights of infrared rays, and comparing to the configuration (i.e., the distribution of brightness) of the reflection lights of infrared rays when the finger is disposed correctly (i.e., under the ideal condition), it is possible to determine on whether it is good or not.

With using the vital authentication apparatus according to the embodiment mentioned above, it is possible to bring almost of parts of optical length into an outside of the apparatus, and thereby achieving small-sizing of the apparatus as a whole. Further, because of non-contacting, it is possible to dissolve the problem of deterioration of the authentication performances, because of the position shift of the finger due to change of a nail shape of a user, or pressure of a vessel due to an influence of compression of the finger, etc.

Namely, with using a technology of vital authentication according to the present embodiment, it is possible to provide a personal authentication apparatus of a viral authentication type, being small/thin in the sizes thereof and for enabling to position the vital or living body with high accuracy. And, it is possible to propagate an installation of the personal authentication apparatus of the vital authentication type onto small-sized mobile equipments (for example, a mobile telephone, etc.)

Also, applying the method of positioning the vital body (for example, the finger, etc.), with using the light source(s) and the detector portion to be used in the vital authentication, for example, there is no necessity of adding the image pickup element, the light source (s) and so on, for the purpose of positioning or the like, newly; therefore, it is possible to reduce a number of parts thereof, and also to reduce production costs of the apparatus.

Heretofore, mentioning is made on the method of disposing the finger 11 to be parallel with and at the correct distance with respect to the apparatus, in a non-contact manner, and on the determination of good or not thereof within an inside of the apparatus; however it is convenient, much more, if it is possible in that process, for the user of the present apparatus to check or confirm the condition of disposing the finger 11.

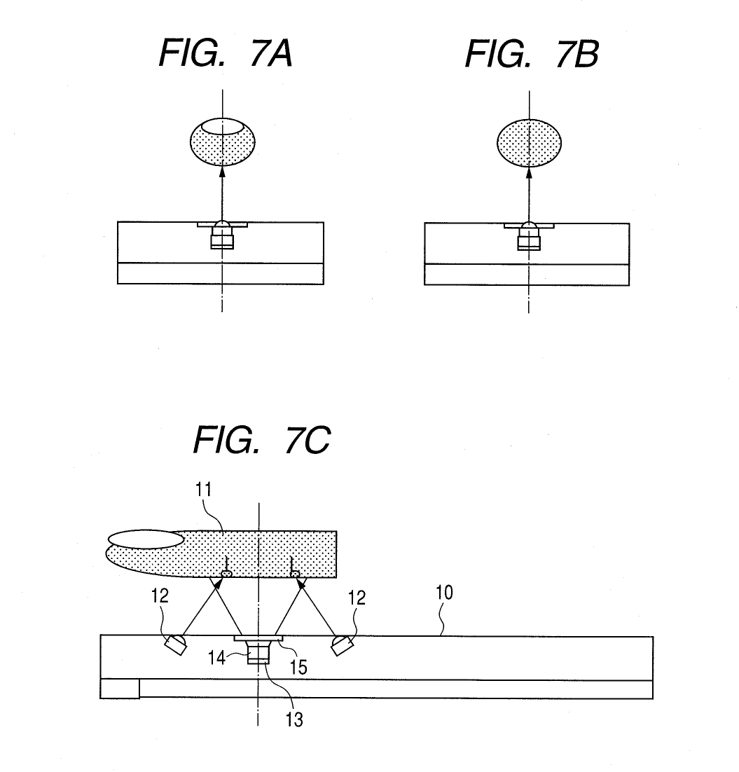

FIGS. 7A to 7C show an example of adding a light source of a visible ray to the light source (s) 12 of the infrared rays, as a means for checking or confirming the condition of disposing the finger by the user. It is assumed that the light source of visible rays is made up with, such as, a LED, for example, like the light source of infrared rays, being received in the same package of the light source of the infrared rays, and has a locus of light rays and a distribution of brightness similar to those of the light source of infrared rays.

Since the reflection light of the visible rays in FIGS. 7A to 7C has a locus of light rays and a distribution of brightness similar to those of the light source of the infrared rays, which are used in the determination of good or not of disposition of the finger 11 within the apparatus, it is possible for the user to check or confirm the condition of disposing the finger 11 while seeing the reflection light of visible rays with the naked eyes as a measure or a criterion. However, the visible rays are not necessary on the checking or confirmation function, and since it comes to be a noise if irradiating it at the same time of the infrared rays, thereby affecting an ill influence on the determination of good or not within the apparatus, therefore it is irradiated alternately, with changing a timing thereof.

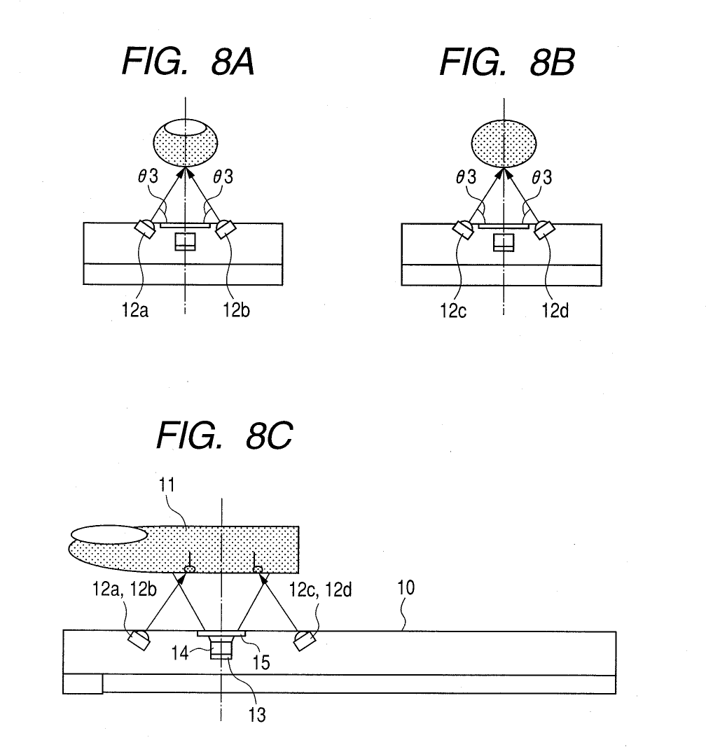

FIGS. 8A to 8C are views, in particular, in case of providing two (2) sets of light sources, i.e., a light source 12a and a light source 12b, on a fingertip side, and two (2) sets of light sources, i.e., a light source 12c and a light source 12d, on a finger-root side, and they show them from the fingertip side and the finger-root side, respectively. In this instance, an irradiation angle “θ3” where the brightness peak of the light source 12a on the fingertip side and the brightness peak of the light source 12b overlap on each other is so determined that it locates at a suitable distance for obtaining the picture of the vein pattern. In the similar manner, the light source 12c and the light source 12d on the finger-root side are also determined. With such determinations or setup, for the user, it is possible to fit the brightness peak on the fingertip side and the brightness peak on the finger-root side, while seeing them with the naked eyes, and thereby enabling to fix the finer with high accuracy.

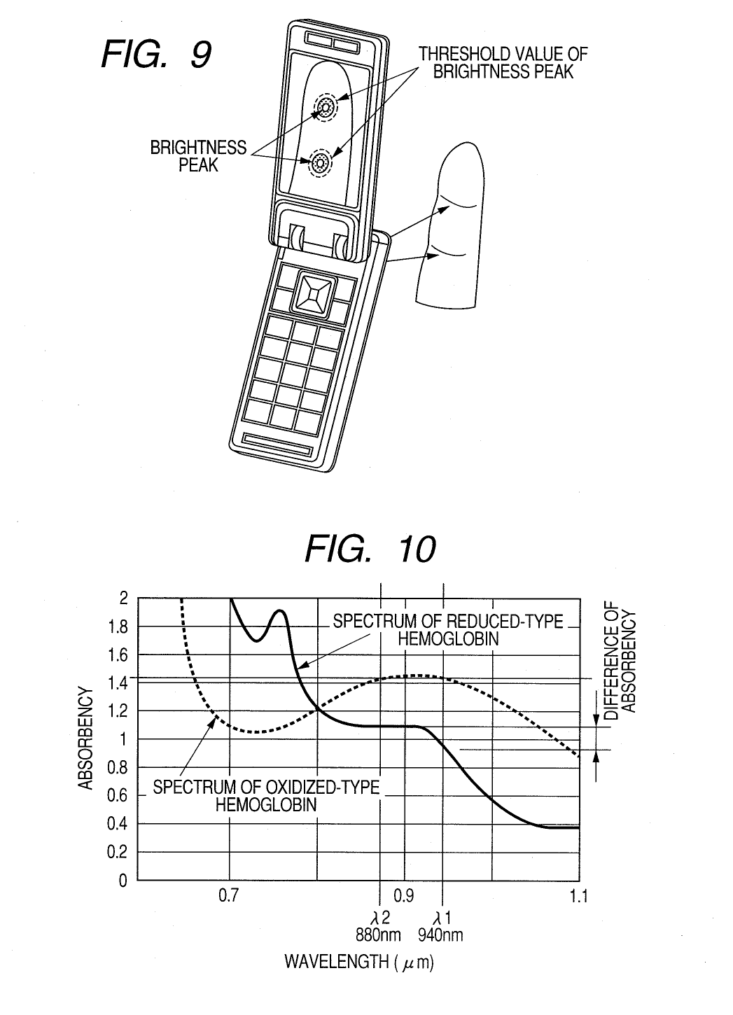

FIG. 9 shows an example of checking or confirming while seeing the picture on a display device within the apparatus, such as, an liquid crystal display, for example, as other one means for the user to check or confirm the condition of disposing the finger 11. In this instance, there is no necessity of the light source of visible rays, and it is possible to check or confirm, while the user sees the screen, i.e., on whether the brightness peak of the reflection light of infrared rays enters or not, into a designated position on a display screen, which is determined in advance. With the case where the finger 11 is twisted (i.e., rotated), it is possible for the user to check or confirm it while seeing the screen, on whether the configuration (i.e., the distribution of brightness) of the reflection light of infrared rays enters or not, into the threshold value on the display screen, which is determined in advance.

Further, as a function for easy operations by the user, it is also possible to have a function of prompting the user to move the finger 11, so that the reflection light of infrared rays enters into the threshold value, which is determined in advance, through a message on the liquid crystal screen within the apparatus or an audio guidance, etc.

With the above-mentioned, when the apparatus determines that the finger 11 is disposed to be in parallel with the apparatus and also at the correct distance, it starts photographing the vein pattern, i.e., the vital characteristic information, for the purpose of registration or authentication; however, in this instance, it is also possible to have a function of noticing to the user, through an indicator, such as, a visible ray light emitting diode or a buzzer, etc., which is provided within the apparatus. Also, on the contrary thereto, when the condition of disposing the finger 11 is bad so that it is impossible to start the photographing the vein pattern, it is also possible to have an function of noticing the user that the photographing of the vein pattern cannot be started, and that the finger 11 should be disposed, again, through the indicator, such as, the visible ray light emitting diode or the buzzer, etc., which is provided within the apparatus.

Next, explanation will be made on a method for obtaining the vein pattern, i.e., the vital characteristic information, for registration or authentication, under the condition of non-contacting of the finger 11 with the apparatus.

First of all, when obtaining the vein pattern, under the condition of non-contact with the apparatus, external lights and/or noise components of reflection lights, etc., result into a large problem. For the purpose of avoiding this problem, there is used a light source of infrared rays, having plural numbers of wavelengths.

FIG. 10 is view for showing absorbency characteristics of hemoglobin included blood. The hemoglobin has two (2) kinds thereof; an oxidized-type hemoglobin and a reduced-type hemoglobin; and that included in the vein much is the reduced-type hemoglobin.

Herein, as a wavelength for obtaining the vein pattern is used two (2) wavelengths of infrared rays having a difference of absorbency of the reduced-type hemoglobin (for example, λ1=940 nm, and λ2=880 nm).

LEDs, etc., having those two (2) wavelengths λ1 and λ2 are stored in the packages of the light sources 12, and they are so determined that each the locus of light rays and the distribution of brightness thereof are similar to.

Also, it is determined or set up, in advance, in such that an intensity of the reflection lights from a surface of the finger 11 is equal, when irradiating the infrared rays λ1 and when irradiating the infrared rays λ2 thereon.

With obtaining the difference between the picture data, which can be obtained on the image pickup element 13 when irradiating the infrared rays λ1 on the finger 11, and the picture data, which can be obtained on the image pickup element 13 when irradiating the infrared rays λ2 on the finger 11, it is possible to cancel the noises, such as, the external lights and the reflection lights from the surface of the finger 11, etc., and also to obtain video information of the vein pattern as the difference of absorbance between the infrared rays λ1 and the infrared rays λ2.

Further, with obtaining this difference data of absorbance by a plural number of times, and compiling up those data, it is possible to obtain a clear vein pattern having fewer noises thereof.

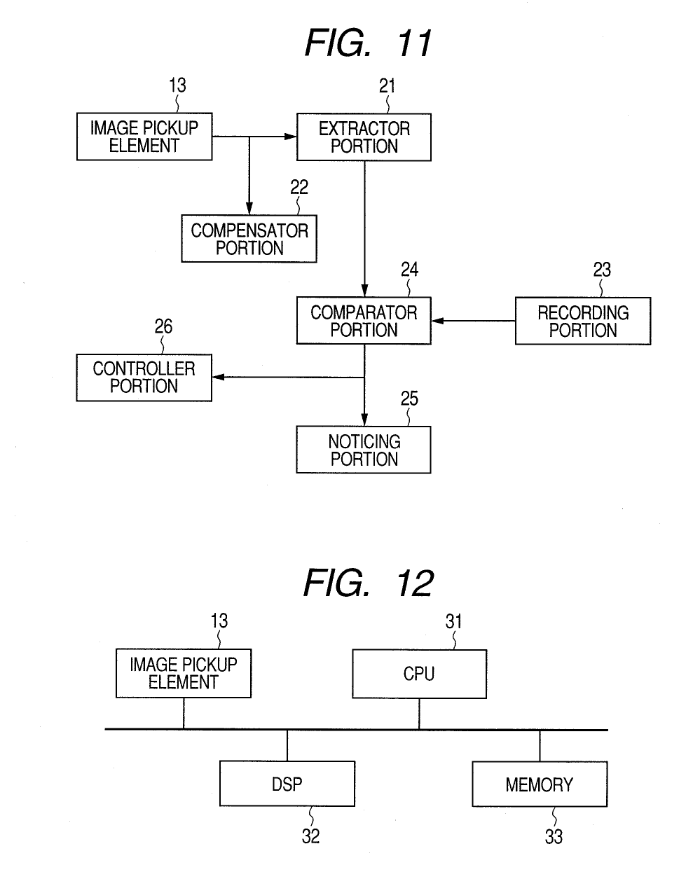

FIG. 11 shows a function block diagram of an image processing apparatus within the vital authentication apparatus. The image processing apparatus comprises an extractor portion 21 for extracting the vein pattern of the finger 11 from the picture, which is photographed by the image pickup element 13 of the detector portion, a compensator portion 22 for compensating distortion of the picture, a recording portion 23 for recording the vein patterns in advance, for every vital or living bodies, a comparator portion 24 for comparing the vein pattern, which is extracted by the extractor portion 21, and the vein pattern, which is recorded in the recording portion 23, a noticing portion 25 for noticing a result of comparison within the comparator portion 24 to the user, etc., and a controller portion 26 for controlling a control target depending upon the result of comparison within the comparator portion 24.

In more details, as is shown in FIG. 12, the image processing apparatus has a CPU (Central Processing Unit) 31 functioning as the extractor portion 21, the comparator portion 24, the noticing portion 25 and the controller portion 26, a DSP (Digital Signal Processor) 32 functioning as a compensator portion 22, and a memory 33 functioning as the recording portion 23.

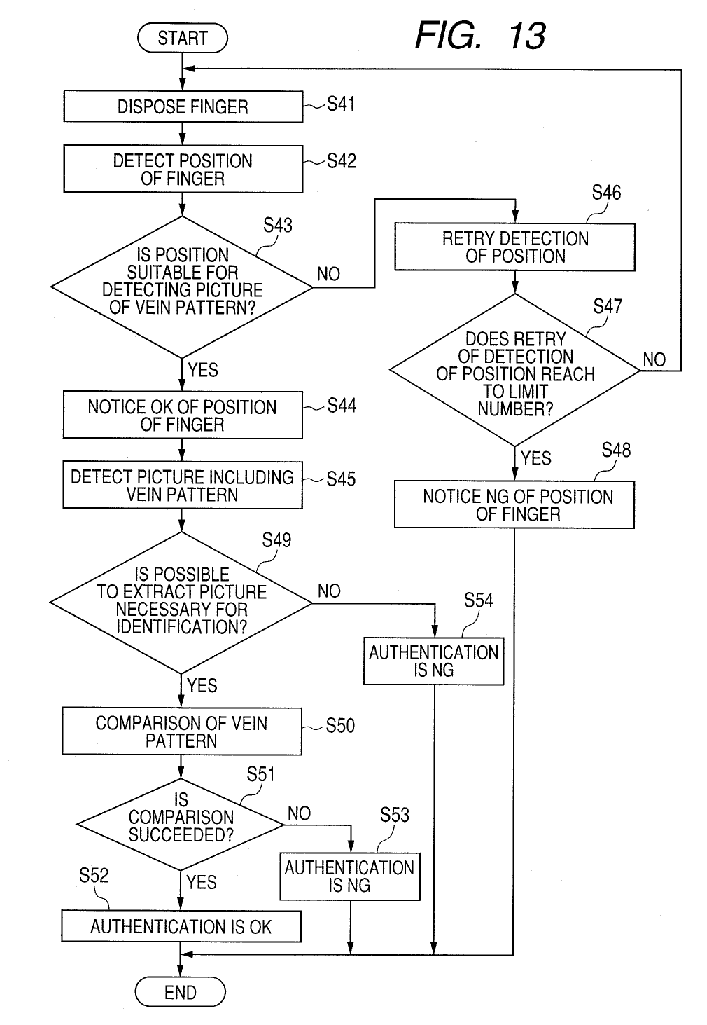

Next, explanation will be given on the functions of the first embodiment of the present invention, in accordance with the flowchart shown in FIG. 13. When the user disposes the finger 11 on an upper portion of the housing 10 (S41), the image pickup element 13 takes a picture of the finger 11, and also detects a picture of the reflection lights of infrared rays irradiated from the light source 12 on the finger 11 (S42). The CPU 31 takes the picture of the image pickup element 13 therein, and thereby determines on whether the finger 11 is in a positioned or not, being suitable for detecting a picture of the vein pattern thereof (S43). In this instance, for the user to make positioning of the finger 11, easily, there may be provided the function of using the reflection light of visible ray as the measure or the criterion as was mentioned above, a function of confirming while seeing the picture on the display device, such as, the liquid crystal panel, etc., within the apparatus, and a function of prompting to dispose the finger 11 in the correct position thereof through the video message and/or the audio guidance, etc.

The CPU 31, when it determines that the finger 11 is in the position suitable for detecting the picture of the vein pattern (OK), notices that the position of the finger 11 is OK to the user (S44), and the image pickup element 13 executes detection of the picture including the vein pattern (S45).

On the other hand, the CPU 31, when it determines that the finger 11 is not in the position suitable for detecting the picture of the vein pattern (NG), retries detection of the position of the finger 11 as mentioned above (S46). In this instance, determining on whether a number of retrying reached or not to a limit number thereof (S47), if it reaches to the limit number, the CPU notices that the position of the finger 11 is NG to the user (S48), and thereby completing the processing in this routine. Turning back to the case when the position of the finger 11 is determined NG, the image pickup element 13 executes detection of the picture including the vein pattern (S45), and the CPU 31 takes the picture of the image pickup element 13 therein; thereby, it executes determination on whether the picture necessary for authentication is extracted or not, in more details, whether the vein pattern, being the characteristic information of a part of the vital or living body, is extracted or not (S49).

The CPU 31, when it determines that the picture necessary for authentication is extracted, refers to the memory 33 upon basis of the characteristic information (i.e., the vein pattern), and executes comparison between the vein pattern extracted and the vain pattern, which is registered in the memory 33 (S50).

Herein, the CPU 31 executes determination on whether the comparison between the vein pattern extracted and the vein pattern registered in the memory is succeeded or not (S51). The CPU 31, when the comparison is succeeded, determines the authentication is succeeded (OK), i.e., it determines that the vein pattern extracted is that of a specific vital or living body (i.e., a user), and notices the user of being succeeded in the authentication (S52), thereby completing the processing in this routine. On the other hand, the CPU 31, when it determines that the comparison is failed, notices the user of failing (NG) in the authentication (S53), and thereby completing the processing in this routine.

On the other hand, in the step S48, when it is determined that the picture necessary for authentication is not extracted from, then the CPU 31 notices the user that extraction of the picture is NG (S54), and thereby completing the processing in this routine.

As was mentioned above, according to the present embodiment, it is possible to small-size the apparatus, by making the finger non-contact with the apparatus, and also by brining almost of the parts of the optical path length, from the vein up to the image pickup element, to an outside of the apparatus, and it is possible to improve the deterioration of authentication performances because of ill influences of the nail shape of the user and the suppression of the finger, which can be found in the conventional method, i.e., brining the finger to be in contact with the apparatus.

However, the present invention should not be restricted to the embodiment mentioned above, but it may include various modifications thereof. For example, the embodiment mentioned above is shown for the purpose of explaining the present invention to be understood, fully and easily, and therefore, the present invention should not be necessarily limited to that comprising all of the constituent elements explained in the above.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A personal authentication apparatus, comprising:
a first light source and a second light source, each of which is configured to irradiate infrared rays; and
detector portion, which is configured to detect the infrared rays irradiated from said first and second light sources upon a vital body, whereby detecting a picture having characteristic information of the vital body from the infrared rays detected by said detector portion and executing a personal authentication, wherein
irradiation is made from said first and second light sources upon the vital body, and position information of the vital body is detected from the infrared rays detected by said detector portion, thereby executing non-contacting positioning of the vital body.

2. The personal authentication apparatus, as described in the claim 1, wherein
the position information of said vital body is brightness information of the infrared rays, which are irradiated from said first and second light sources upon the vital body and are detected by said detector portion.

3. The personal authentication apparatus, as described in the claim 2, wherein
the non-contact positioning of the vital body is executed by detecting a peak of brightness from said brightness information.

4. The personal authentication apparatus, as described in the claim 3, wherein
said first light source and said second light source are disposed at positions, being nearly symmetric around said detector portion as a center thereof.

5. The personal authentication apparatus, as described in the claim 1, wherein
each of said first and second light sources is able to irradiate a visible light therefrom.

6. The personal authentication apparatus, as described in the claim 5, wherein
each of said first and second light sources has a function of irradiating the infrared ray and the visible light alternately therefrom.

7. The personal authentication apparatus, as described in the claim 1, wherein
the position information of the vital body, which is detected by said detector portion, is outputted as video information, to be displayed.

8. The personal authentication apparatus, as described in the claim 1, further comprising:
means for noticing a user that a personal authentication is started by photographing a picture having vital body characteristic information.

9. The personal authentication apparatus, as described in the claim 1, further comprising:
a function of noticing a user that the position of the vital body is not appropriate, upon basis of the position information of the vital body from the infrared rays detected by said detector portion, thereby prompting the user to move a part of the vital body.

10. The personal authentication apparatus, as described in the claim 1, wherein
said first and second light sources are able to irradiate infrared ray of a second wavelength different from the infrared ray of a first wavelength and said first wavelength, respectively.

11. The personal authentication apparatus, as described in the claim 10, wherein
the infrared ray of said first wavelength and the infrared ray of said second wavelength, which are irradiated from said first and second light sources, are detected by said detector portion, and
the picture having the vital body characteristic information is detected, with using the infrared ray of said first wavelength and the infrared ray of said second wavelength, which are detected by said detector portion, and thereby executing the personal authentication.

12. A mobile communication terminal comprising:
a personal authentication apparatus, as described in the claim 1; and
communication means for conducting communication between an outside.
